(19) United States
(12) Patent Application Publication
(10) Pub. No.: US 2026/0243110 A1
(43) Pub. Date: Aug. 20, 2026

(54) LOCK MECHANISM AND MONEY HANDLING DEVICE

(71) Applicant: Oki Electric Industry Co., Ltd., Tokyo (JP)

(72) Inventors: Daiki YAMAGUCHI, Tokyo (JP); Nobuharu NISHINO, Tokyo (JP)

(73) Assignee: Oki Electric Industry Co., Ltd., Tokyo (JP)

(21) Appl. No.: 18/995,037

(22) PCT Filed: Jul. 12, 2023
(86) PCT No.: PCT/JP2023/025788

§ 371 Date: Jan. 15, 2025

(30) Foreign Application Priority Data
Oct. 4, 2022 (JP) 2022-160281

(51) Int. Cl. E05B 65/46; G07D 11/125

(52) U.S. Cl. CPC E05B 65/461; G07D 11/125

(57) ABSTRACT

A lock mechanism that includes a release lever rotatable in a locking direction and an unlocking direction interlocked with rotation of a key insertion portion, a lock lever provided to contact when the release lever is rotated in the unlocking direction, that permits pull out to outside when the lock section is unlocked, and that limits pull out to outside when the lock section is locked. The release lever is provided with a curve-shaped corner portion that abuts the lock lever by rotating in the unlocking direction and transitions to a permitted state permitting pull out, and a left side-edge portion that abuts the lock lever by rotating further in the unlocking direction after the lock lever has been transitioned to the permitted state, and that holds the permitted state of the lock lever.

### TECHNICAL FIELD

The present disclosure relates to a lock mechanism and a money handling device.

### BACKGROUND ART

Money handling devices are known that are employed in a financial institution, a backyard retailer, a collection and distribution center of a delivery service business, or the like (see, for example, Japanese Patent Application Laid-Open (JP-A) No. 2015-125517 (Patent Document 1)). As illustrated in FIG. 6A and FIG. 6B, a money handling device 101 thereof is equipped with a coin housing section 103 to house coins by denomination. FIG. 6A and FIG. 6B are perspective views of a conventional money handling device 101, with FIG. 6A illustrating a pulled-out state of the coin housing section 103 pulled out from a device main body 102, and FIG. 6B illustrating a stowed state of the coin housing section 103 stowed inside the device main body 102. This coin housing section 103 is able to be pulled out from the device main body 102, and plural hoppers 103a (coin housing boxes) are disposed in a straight line row along the pull-out direction (and stowing direction). Each of the hoppers 103a houses coins of a single type from out of various denominations (500 yen, 100 yen, 50 yen, 10 yen, 5 yen, and 1 yen). The money handling device 101 is equipped with a lock mechanism 104. A key to the lock mechanism 104 is provided, and pull-out of the coin housing section 103 from the device main body 102 is limited in a locked state.

Description follows regarding the conventional lock mechanism 104, with reference to FIG. 7A, FIG. 7B, FIG. 8A, and FIG. 8B. FIG. 7A and FIG. 7B are side views of the conventional lock mechanism 104, and FIG. 8A and FIG. 8B are front views of the conventional lock mechanism 104. FIG. 7A and FIG. 8A illustrate states (locked states) in which pull-out of the coin housing section 103 is limited, and FIG. 7B and FIG. 8B illustrate states (unlocked states) in which pull-out of the coin housing section 103 is permitted. As illustrated in FIG. 7A, FIG. 7B, FIG. 8A, and FIG. 8B, the conventional lock mechanism 104 is mainly equipped with a lock section 110, a lock lever 120, and a lock lever receiver 130.

The lock section 110 and the lock lever 120 are provided to the coin housing section 103, and the lock lever receiver 130 is provided to the device main body 102. Note that FIG. 8A and FIG. 8B depict the lock lever 120 in cross-section.

As illustrated in FIG. 8A and FIG. 8B, the lock section 110 is equipped with a release lever 112, a non-illustrated key is inserted into a keyhole 111a in the state illustrated in FIG. 8A and rotated clockwise (right-handed rotation), such that the release lever 112 is rotated clockwise interlocked thereto (see FIG. 8B). The lock lever 120 illustrated in FIG. 7A and FIG. 7B is a member that limits pull-out of the coin housing section 103 (see FIG. 7A) by engaging with the lock lever receiver 130. The lock lever 120 is axially supported by a shaft portion 129 disposed along a left-right direction. The lock lever 120 is rotated counterclockwise (left-handed rotation) by a front-end portion thereof being pressed up by the release lever 112, an engagement portion 123 formed to a rear end portion thereof comes out from a hole 131 in the lock lever receiver 130, thereby releasing the pull-out limitation from the lock lever 120. The coin housing section 103 is accordingly able to move forward.

A lock lever spring 128 is provided to the shaft portion 129 of the lock lever 120. The lock lever spring 128 imparts a biasing force to rotate the lock lever 120 in a clockwise (right-handed rotation) direction. This means that in cases in which a rotation force to rotate the lock lever 120 counterclockwise (left-handed rotation) is no longer being externally imparted thereto, then the lock lever 120 returns from the state illustrated in FIG. 7B to the state illustrated in FIG. 7A under the rotation force from the lock lever spring 128. The release lever 112 is returned from the state illustrated in FIG. 8B to the state illustrated in FIG. 8A accompanying this action.

### SUMMARY OF INVENTION

### Technical Problem

A commercially available lock generally includes a function to be unlocked by rotating a key by “90°”, and to hold this “90°” position. This means that fundamentally a rotated position (unlocked state) is held by a holding force of the lock. However, in the conventional money handling device 101 described with reference to FIG. 6A and FIG. 6B to FIG. 8A and FIG. 8B, there is no implementation space to rotate the lock section 110 (in particular the release lever 112) by “90°” (namely, as illustrated in FIG. 8B, this is not a structure in which the release lever 112 can be rotated by “90°”), with it not having been possible to hold a position (unlocked state) in which the release lever 112 has been rotated by a function provided to the lock. This means that when rotation force stops being imparted to the lock lever 120 by an operator operating a key, the lock lever 120 is rotated by biasing force of the lock lever spring 128, re-adopting a state in which pull-out is limited. To pull out the coin housing section 103 (pull-out section) there has accordingly been a need to continuously operate the key to keep the unlocked position. As a result thereof, there is no option by to perform this task with both hands (in order to performed an operation to pull out the coin housing section 103 (pull-out section) in addition to operating the key), with this being an issue regarding poor operability.

In consideration of the above issue, the present invention provides a lock mechanism and a money handling device that have operability superior to hitherto.

### Solution to Problem

In order to address the above issue, a lock mechanism according to an aspect of the present invention limits pull-out to outside of a pull-out section provided capable of being stowed inside a casing and also capable of being pulled out to outside from the inside thereof. The lock mechanism includes a lock section including a key insertion portion that is able to be rotated by a specific key being inserted therein, a release lever that is able to rotate in a locking direction and an unlocking direction interlocked with rotation of the key insertion portion, and a lock lever that is provided at a position to contact the release lever when the release lever is rotated in the unlocking direction, that permits pull out to outside of the pull-out section when the lock section is in an unlocked state, and that limits pull out to outside of the pull-out section when the lock section is in a locked state. The release lever is provided with a first abutting section that abuts the lock lever by rotation in the unlocking direction and transitions the lock lever to a permitted state permitting pull out of the pull-out section, and a second abutting section that abuts the lock lever by further rotation in the unlocking direction after the lock lever has been transitioned to the permitted state, and that holds the permitted state of the lock lever.

Moreover, in order to address such a problem, a money handling device according to an aspect of the present invention is a money handling device including a casing, a coin housing section that is provided so as to be capable of being stowed inside the casing and also capable of being pulled out to outside from the inside thereof, and that houses coins by denomination, and a lock mechanism that limits pull out to outside of the coin housing section. The lock mechanism includes a lock section including a key insertion portion that is able to be rotated by a specific key being inserted therein, a release lever that is able to rotate in a locking direction and an unlocking direction interlocked with rotation of the key insertion portion, and a lock lever that is provided at a position to contact the release lever when the release lever is rotated in the unlocking direction, that permits pull out to outside of the coin housing section when the lock section is in an unlocked state, and that limits pull out of the coin housing section to outside when the lock section is in a locked state. The release lever is provided with a first abutting section that abuts the lock lever by rotation in the unlocking direction and transitions the lock lever to a permitted state permitting pull out of the coin housing section, and a second abutting section that abuts the lock lever by further rotation in the unlocking direction after the lock lever has been transitioned to the permitted state, and that holds the permitted state of the lock lever.

The present invention has superior operability to hitherto.

### BRIEF DESCRIPTION OF DRAWINGS

FIG. 1 is a schematic diagram illustrating an example of an internal configuration of a money handling device according to an exemplary embodiment of the present invention.

FIG. 2 is a side view of a lock mechanism according to an exemplary embodiment of the present invention, and illustrates a state (locked state) in which pull-out of a coin housing section is limited.

FIG. 3 is a side view of a lock mechanism according to an exemplary embodiment of the present invention, and illustrates a state (unlocked state) in which pull-out of a coin housing section is permitted, this being a state (held unlocked state) in which the unlocked state is being held.

FIG. 4 is a front view of a lock mechanism according to an exemplary embodiment of the present invention, (1) illustrates a state (locked state) in which pull-out of a coin housing section has been limited, (2) illustrates a state (unlocked state) in which pull-out of a coin housing section has been permitted, this being a state (non-held unlocked state) in which the unlocked state is not being held, and (3) illustrates state (unlocked state) in which pull-out of a coin housing section is permitted, this being a state (held unlocked state) in which the unlocked state is being held. Note that part of the configuration thereof is illustrated in cross-section.

FIG. 5 is a diagram to explain a principle that enables an unlocked state to be held. Note that part of the configuration thereof is illustrated in cross-section.

FIG. 6A is a perspective view of a conventional money handling device, and illustrates a state in which a coin housing section has been pulled out from a device main body.

FIG. 6B is a perspective view of a conventional money handling device, and illustrates a state in which a coin housing section has been stowed inside a device main body.

FIG. 7A is a side view of a conventional lock mechanism, and illustrates a state (locked state) in which pull-out of a coin housing section has been limited.

FIG. 7B is a side view of a conventional lock mechanism, and illustrates a state (unlocked state) in which pull-out of a coin housing section is permitted.

FIG. 8A is a front view of a conventional lock mechanism, and illustrates a state (locked state) in which pull-out of a coin housing section has been limited. Note that part of the configuration thereof is illustrated in cross-section.

FIG. 8B is a front view of a conventional lock mechanism, and illustrates a state (unlocked state) in which pull-out of a coin housing section is permitted. Note that part of the configuration thereof is illustrated in cross-section.

### DESCRIPTION OF EMBODIMENTS

Detailed explanation follows regarding an exemplary embodiment of the present invention, with reference to the drawings. Each of the drawings is merely schematically illustrated to such an extent as to enable sufficient understanding of the present invention.

The present invention is accordingly not limited to only the examples illustrated. Moreover, in each of the drawings for reference, dimensions of members configuring the present invention are sometimes exaggerated or minimized for ease of explanation. Note that the same reference numerals are appended to configuration elements common across the drawings and similar configuration element therein, and duplicate explanation is omitted thereof.

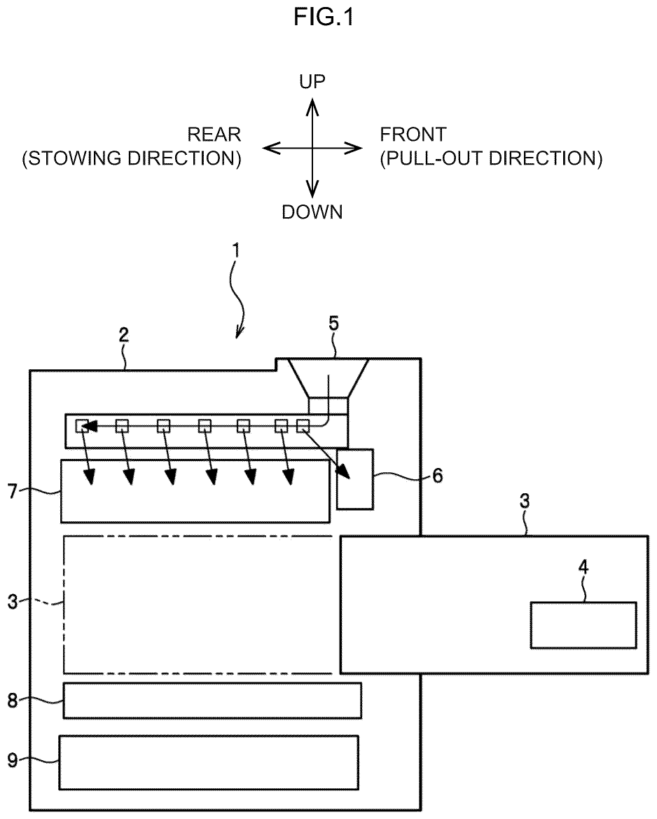

Configuration of Money Handling Device According to Exemplary Embodiment Description follows regarding a configuration of a money handling device 1 according to an exemplary embodiment, with reference to FIG. 1. FIG. 1 is a schematic diagram illustrating an example of an internal configuration of the money handling device 1 according to an exemplary embodiment of the present invention.

The money handling device 1 is a device for handling money (and in particular coins). The present exemplary embodiment will be described envisaging a pay-in/pay-out machine employed in a financial institution, a backyard retailer, a collection and distribution center of a delivery service business, or the like. Note that the money handling device 1 is not limited to being a pay-in/pay-out machine and may, for example, be an automated teller machine (ATM), a coin machine, a self-checkout machine, or the like. In the description of the money handling device 1, “up-down” and “front-rear” are according to the arrows in FIG. 1. The front direction of FIG. 1 corresponds to a pull-out direction of a pull-out section, and the rear direction of FIG. 1 corresponds to a stowing direction of the pull-out section. These directions are defined for ease of explanation only, and are not limitations to the present invention. Note that “left and right” are defined as directions when the money handling device 1 is being viewed from the front.

As illustrated in FIG. 1, the money handling device 1 includes a pay-in processing section 5, a reject section 6, a temporary pay-in box 7, a coin housing section 3, a temporary pay-out box 8, and a collection cassette 9.

The pay-in processing section 5 is a configuration element to receive cash from an operator and to pay-in the cash into the device interior.

The reject section 6 is a configuration element that serves as a dispensing port for dispensing to the device exterior in cases in which something other than cash, or foreign currency and the like, has been paid in to the pay-in processing section 5.

The temporary pay-in box 7 is a configuration element assigned with processing to return or to store paid in cash.

The coin housing section 3 is a configuration element serving as a storage box for paid in cash, and for paying out the stowed cash.

The temporary pay-out box 8 is a configuration element that sorts cash paid in from the coin housing section 3 to a cash transaction position or to a position to collect cash in the device interior.

The collection cassette 9 is a configuration element to house cash for collection from the money handling device 1.

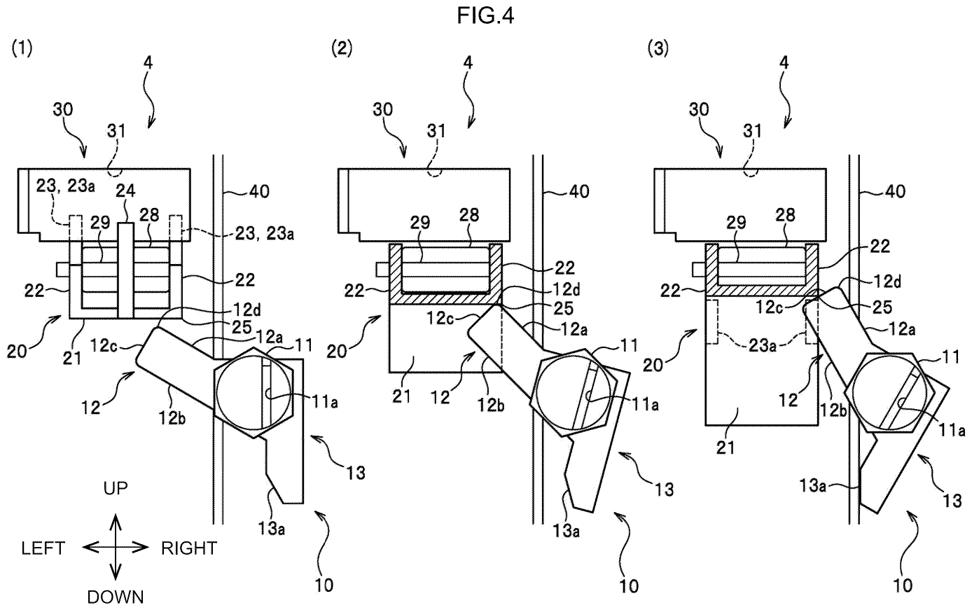

The coin housing section 3 illustrated in FIG. 1 is able to be stowed inside a casing of a device main body 2, and is able to be pulled out from the device main body 2. Plural hoppers are arranged in the coin housing section 3 in a straight line row along the front-rear direction. Each of the hoppers houses one type of coin from out of various denominations (500 yen, 100 yen, 50 yen, 10 yen, 5 yen, and 1 yen). The coin housing section 3 is able to be pulled out forward from a state stowed inside the device main body 2 (see the double-dot broken lines in FIG. 1). The money handling device 1 includes a lock mechanism 4 that limits an operation to pull out the coin housing section 3 such that an unauthorized person is not able to perform a pull-out operation on the coin housing section 3. A lock section 10 (see FIG. 4) is provided to the lock mechanism 4, with pull-out of the coin housing section 3 limited in a locked state, and pull-out limitation of the coin housing section 3 being released (permitted) by the lock section 10 being unlocked. Note that the coin housing section 3 is an example of a “pull-out section”.

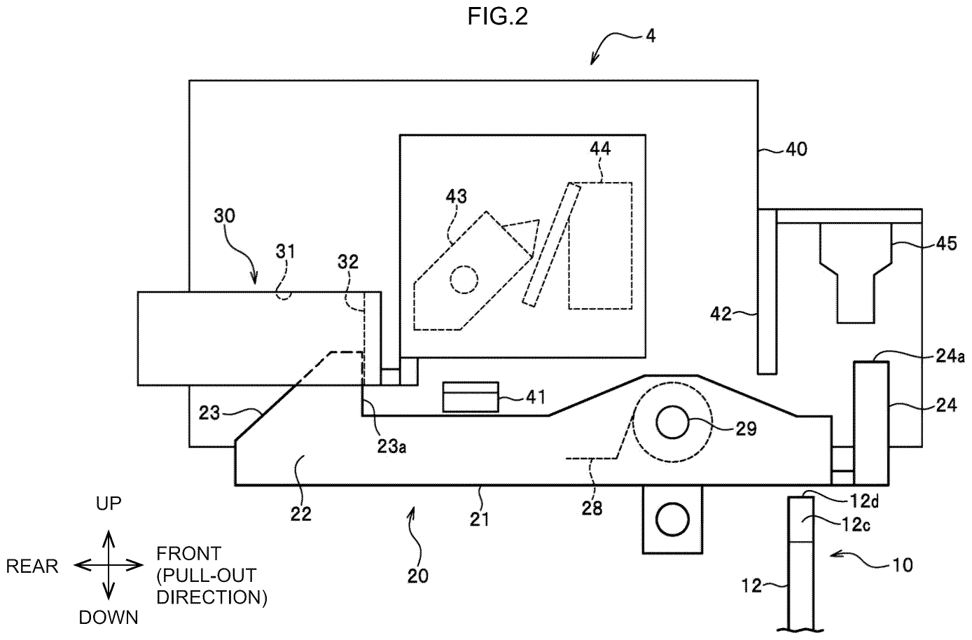

Description follows regarding the lock mechanism 4 according to the present exemplary embodiment, with reference to FIG. 2 to FIG. 4.

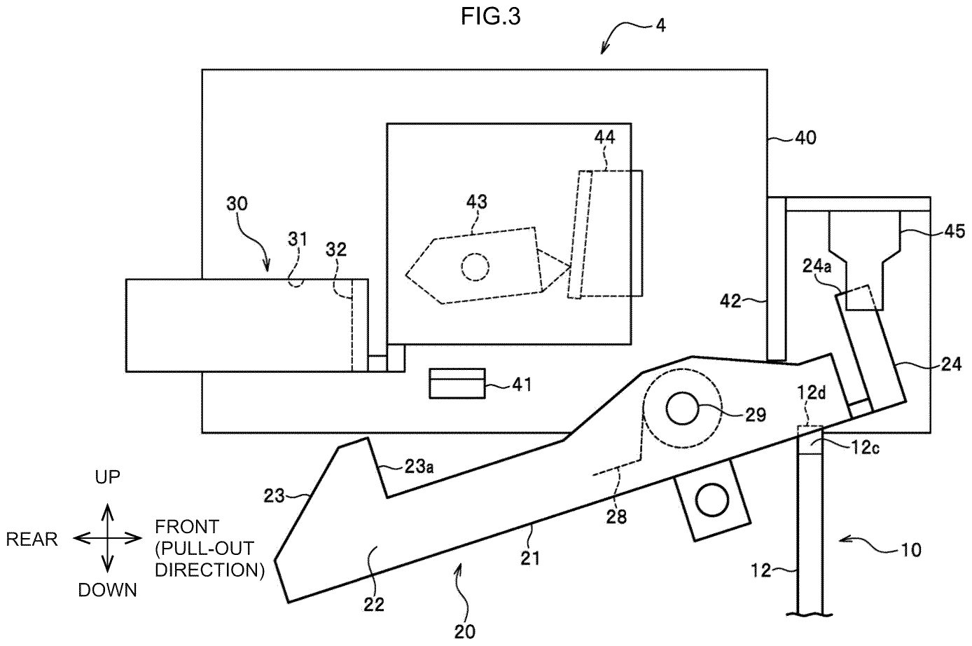

FIG. 2 and FIG. 3 are side views of the lock mechanism 4 according to the present exemplary embodiment. FIG. 2 illustrates a state (locked state) in which pull-out of the coin housing section 3 is limited, FIG. 3 illustrates a state (unlocked state) in which pull-out of the coin housing section 3 is permitted and that is also a state (held unlocked state) in which the unlocked state is held. The held unlocked state is configured so as not to return to the locked state even when the hand of an operator is removed from the key.

FIG. 4 is front view of the lock mechanism 4 according to the present exemplary embodiment. FIG. 4 (1) illustrates a state (locked state) in which pull-out of the coin housing section 3 is limited, (2) illustrates a state (unlocked state) in which pull-out of the coin housing section 3 is permitted and is also a state (non-held unlocked state) in which the unlocked state is not held, (3) illustrates a state (unlocked state) in which pull-out of the coin housing section 3 is permitted and is also a state (held unlocked state) in which the unlocked state is held. FIG. 4 (1) corresponds to FIG. 2, and FIG. 4 (3) corresponds to FIG. 3. FIG. 4. (2) is a state partway through a process of transitioning from the state of FIG. 4 (1) to the state of FIG. 4 (3). Note that a lock lever 20 is depicted in cross-section in FIG. 4 (2) and (3).

As illustrated in FIG. 2 to FIG. 4, the lock mechanism 4 mainly includes the lock section 10, the lock lever 20, and a lock lever receiver 30. The lock section 10 and the lock lever 20 are provided to the coin housing section 3, and the lock lever receiver 30 is provided to the device main body 2.

As illustrated in FIG. 4, the lock section 10 includes a key insertion portion 11, a release lever 12, and a release lever limiter section 13.

The key insertion portion 11 illustrated in FIG. 4, exhibits a tube shape with the front-rear direction (the direction into and out of the page in FIG. 4) as an axial center, and is able to rotate in a state housed in a non-illustrated external cylinder about the front-rear direction as the center axis. A keyhole 11a is formed in the key insertion portion 11, and the key insertion portion 11 is able to rotate by a specific key being inserted into the keyhole 11a. The release lever 12 is able to rotate interlocked to rotation of the key insertion portion 11 (rotate as a single unit with the key insertion portion 11 in the present exemplary embodiment).

The state illustrated in FIG. 4 (1) is a state in which the lock section 10 has been locked (referred to as a “locked state”), and the states illustrated in FIG. 4 (2) and (3) are states in which the lock section 10 is unlocked (referred to as “unlocked states”). FIG. 4 (2) is a state in which the unlocked state is not held (non-held unlocked state), and (3) is a state in which the unlocked state is held (held unlocked state). Pull-out of the coin housing section 3 is limited in the locked state illustrated in FIG. 4 (1). Note that the key for insertion in the keyhole 11a is omitted in FIG. 4.

The release lever 12 illustrated in FIG. 4 is a member to release pull-out limitation of the coin housing section 3. Interlocked to the key insertion portion 11, the release lever 12 is, according to a locking operation or unlocking operation using the non-illustrated key, able to rotate in a locking direction (counterclockwise (left-handed rotation)) and unlocking direction (clockwise (right-handed rotation)) that is the reverse direction to the locking direction. The rotation center axis of the release lever 12 is the same as the rotation center axis of the key insertion portion 11.

As illustrated in FIG. 2, the release lever 12 exhibits a plate shape having a specific thickness. As illustrated in FIG. 4, the release lever 12 is provided projecting in the left direction from the key insertion portion 11, with a leading end of the release lever 12 positioned below the lock lever 20. The release lever 12 is able to raise the front end side of the lock lever 20 (see FIG. 4 (2) and (3)) by rotating clockwise from the position illustrated in FIG. 4 (1). Namely, in the locked state illustrated in FIG. 4 (1), the release lever 12 does not contact the lock lever 20. In the unlocked state illustrated in FIG. 4 (2) and (3), the release lever 12 presses up the lock lever 20.

The release lever 12 in the present exemplary embodiment results from rounding corner portions of a plate member exhibiting a substantially square shape (is configured with a circular arc shaped cross-section profile). The release lever 12 includes an upper side-edge portion 12a, a lower side-edge portion 12b, a left side-edge portion 12c, and a curve-shaped corner portion 12d provided between the upper side-edge portion 12a and the left side-edge portion 12c. The release lever 12 is disposed in a horizontal plane orthogonal to the rotation center axis of the key insertion portion 11 (in a flat plane configured up-down and left-right), and an edge portion thereof abuts the lock lever 20. Specifically, the curve-shaped corner portion 12d abuts first due to the release lever 12 rotating in the unlocking direction (clockwise rotation) from the position illustrated in FIG. 4 (1), and by then continuing to rotate (see FIG. 4 (2)) presses the lock lever 20 up with the curve-shaped corner portion 12d. Then, by rotating in the unlocking direction (clockwise rotation) further from the position illustrated in FIG. 4 (2), the abutting portion of the release lever 12 transitions from the curve-shaped corner portion 12d to the left side-edge portion 12c, such that it is the left side-edge portion 12c of the release lever 12 finally abutting the lock lever 20 (see FIG. 4 (3)).

As illustrated in FIG. 4 (3), the release lever limiter section 13 is provided on the opposite side to the release lever 12, and an abutting portion 13a thereof is a site that limits further rotation in the unlocking direction (clockwise rotation) by contacting a frame 40 of the coin housing section 3. There is no particular limitation to the shape of the release lever limiter section 13, and any shape capable of limiting rotation of the release lever 12 at a predetermined position may be employed therefor. In the present exemplary embodiment, a configuration is adopted such that the release lever limiter section 13 limits rotation of the release lever 12 at a position where the left side-edge portion 12c of the release lever 12 abuts a corner portion 25 configured by a bottom portion 21 of the lock lever 20 and a right side wall portion 22. An angle rotated from the state illustrated in FIG. 4 (1) to the state illustrated in FIG. 4 (3) is less than “90” and is, for example, in a range of “10° to 60”.

The lock lever 20 illustrated in FIG. 2 and FIG. 3 is a member that limits pull-out of the coin housing section 3 by engaging with the lock lever receiver 30. As illustrated in FIG. 2, the lock lever 20 is a member elongated in the front-rear direction. The lock lever 20 is axially supported by a shaft portion 29 arranged along the left-right direction, and is able to rotate about the shaft portion 29. Namely, the shaft portion 29 serves the role of a fulcrum of the lock lever 20. The shaft portion 29 is fixed to a freely selected portion (for example, the frame 40) of the coin housing section 3. The lock lever 20 is provided at a position that does not make contact with the release lever 12 in the locked state, and that does make contact therewith by the release lever 12 being rotated in the unlocking direction (see FIG. 4).

As illustrated in FIG. 4, the lock lever 20 includes the flat plate shaped bottom portion 21, and the pair of side wall portions 22 respectively upstanding from the left and right sides of the bottom portion 21. The shapes are similar for the left-side and right-side wall portions 22. The bottom portion 21 exhibits a rectangular shape having a long side along the front-rear direction and a short side along the left-right direction, and the side wall portions 22 have front-rear direction dimensions that are larger than left-right direction dimensions. The lock lever 20 is, for example, manufactured by bending both sides of a rectangular shaped plate member in the same direction. The shaft portion 29 passes through the pair of side wall portions 22 as a shaft. The shaft portion 29 is parallel to the bottom portion 21. The bottom portion 21 includes a bottom face in a flat plane, and the side wall portions 22 also include side faces in flat planes. The bottom face of the bottom portion 21 is at right angles to the side faces of the side wall portions 22.

As illustrated in FIG. 2 and FIG. 3, the rotatable range of the lock lever 20 is limited by a first limiter 41 and a second limiter 42. The first limiter 41 and the second limiter 42 are fixed to the frame 40 of the coin housing section 3.

The first limiter 41 is disposed at the rear of the shaft portion 29, and further rotation in the locking direction (clockwise rotation) is limited by a center portion of the lock lever 20 contacting a bottom portion of the first limiter 41 (see FIG. 2). In the present exemplary embodiment, the bottom portion 21 of the lock lever 20 is parallel to a horizontal plane (flat plane configured front-rear and left-right) in a state in which the lock lever 20 has contacted the first limiter 41 (a state in which rotation in the clockwise rotation direction of the lock lever 20 is limited).

The second limiter 42 is disposed in front of and diagonally above the shaft portion 29, and further rotation in the unlocking direction (counterclockwise rotation) is limited by a front-side portion of the lock lever 20 contacting a bottom portion of the second limiter 42 (see FIG. 3). In the present exemplary embodiment, the bottom portion 21 of the lock lever 20 is inclined with respect to a horizontal plane (flat plane configured front-rear and left-right) in a state in which the lock lever 20 has contacted the second limiter 42 (a state in which rotation of the lock lever 20 in the counterclockwise rotation direction is limited).

As illustrated in FIG. 2, a lock lever spring 28 is provided on the shaft portion 29. The lock lever spring 28 imparts a biasing force to rotate the lock lever 20 in the locking direction (clockwise rotation). The lock lever spring 28 is an example of a biasing means. The lock lever 20 is supported in the locked state illustrated in FIG. 2 by the lock lever spring 28 biasing the lock lever 20 in the locking direction and pressing the lock lever 20 against the first limiter 41. Pull-out of the coin housing section 3 is limited in the locked state illustrated in FIG. 2. The locked state is accordingly a “limited state” that limits the pull-out of the coin housing section 3. Note that a position of the lock lever 20 in the pull-out limited state (locked state) illustrated in FIG. 2 is called a “limited position”.

Moreover, by inserting a non-illustrated key in the keyhole 11a (see FIG. 4) and rotating in the unlocking direction (clockwise rotation), the release lever 12 is rotated interlocked thereto, and the curve-shaped corner portion 12d of the release lever 12 contacts the bottom portion 21 of the lock lever 20. By rotating the key further in the unlocking direction (clockwise rotation) from such a state, the release lever 12 further rotates the lock lever 20 in an unlocking direction (counterclockwise rotation), and a front side portion of the lock lever 20 is raised up against elastic force arising from deformation of the lock lever spring 28. Namely, a force that becomes a rotation force to rotate the lock lever 20 in the unlocking direction (counterclockwise rotation) is a force for unlocking with which an operator rotates a key in the unlocking direction (clockwise rotation).

Then when the lock lever 20 has abutted a bottom portion of the second limiter 42 after the lock lever 20 has been rotated by a specific amount in the unlocking direction (counterclockwise rotation), as illustrated in FIG. 3, further rotation in the unlocking direction is limited. Pull-out of the coin housing section 3 is permitted in the unlocked state illustrated in FIG. 3. This means that this unlocked state is a “permitted state” permitting pull-out of the coin housing section 3. Note that a position of the lock lever 20 in the pull-out permitted state (unlocked state) illustrated in FIG. 3 is called a “permitted position”. Note that the lock lever 20 is in the permitted state even in the state illustrated in FIG. 4 (2).

In cases in which, in the state illustrated in FIG. 3, rotation force (biasing force) to rotate the lock lever 20 with counterclockwise rotation is no longer imparted from the release lever 12, the lock lever 20 is rotated with clockwise rotation by elastic force arising as deformation of the lock lever spring 28 tries to return to its original state. As illustrated in FIG. 2, the lock lever 20 then abuts the bottom portion of the first limiter 41 and is limited from further rotation, and the lock lever 20 naturally returns to a state (limited state) in which pull-out of the coin housing section 3 is limited.

As illustrated in FIG. 2, an engagement portion 23 is provided projecting upward at a rear end portion of the lock lever 20. The engagement portion 23 is a portion that engages with the lock lever receiver 30 in the locked state. The engagement portion 23 includes an abutting portion 23a that abuts with a member on the lock lever receiver 30 side. The abutting portion 23a is formed at a front side of the engagement portion 23 and, when an attempt is made to pull out the coin housing section 3, limits pull-out of the coin housing section 3 by contacting a bearing face 32 of the lock lever receiver 30 in the locked state. The abutting portion 23a in the present exemplary embodiment is configured as respective portions of edges of the left and right side wall portions 22. The abutting portion 23a is orthogonal to the bottom portion 21 of the lock lever 20. As illustrated in FIG. 2, the abutting portion 23a is orthogonal to the pull-out direction and stowing direction when the lock lever 20 is in a state disposed along the pull-out direction and stowing direction (in this case the front-rear direction) of the coin housing section 3. The abutting portion 23a may also exhibit a planar shape.

The lock lever receiver 30 illustrated in FIG. 2 and FIG. 3 is a member that performs a role of receiving the lock lever 20 that limits pull-out of the coin housing section 3. There is no particular limitation to the position, shape, or the like of the lock lever receiver 30 as long as it is able to engage with the lock lever 20 such that pull-out is limited by the lock lever 20. The lock lever receiver 30 according to the present exemplary embodiment includes the hole 31 that the engagement portion 23 of the lock lever 20 is able to be inserted into. The hole 31 is formed at a position facing the engagement portion 23, and includes the bearing face 32 corresponding to the abutting portion 23a. The bearing face 32 is orthogonal to the pull-out direction and stowing direction (in this case the front-rear direction) of the coin housing section 3.

By an operator performing an unlocking operation of the lock mechanism 4 in the state illustrated in FIG. 2, the release lever 12 presses up the front-end portion of the lock lever 20, the engagement portion 23 of the lock lever 20 moves downward and comes out from the hole 31 of the lock lever receiver 30, and pull-out limitation by the lock lever 20 is released. Forward movement of the coin housing section 3 is thereby enabled.

Note that in the pull-out limited state (locked state) illustrated in FIG. 2, the abutting portion 23a and the bearing face 32 may be disposed not abutting each other (there may be a slight gap therebetween), with the abutting portion 23a abutting the bearing face 32 when the coin housing section 3 is pulled out.

As illustrated in FIG. 2, the lock lever 20 of the present exemplary embodiment has a larger distance from the shaft portion 29 to the engagement portion 23 than a distance from the shaft portion 29 to the contact point with the release lever 12. This means that a sufficient distance can be achieved to move the engagement portion 23 from the restricted position to the permitted position even when a push-up distance by the release lever 12 is small. This means that a configuration can be achieved so as to enable switching between limiting or releasing pull-out of the coin housing section 3 to be performed even when an angle to rotate the key is set as a smaller angle.

Moreover, as illustrated in FIG. 2, a detector 24 is provided at a front-end portion of the lock lever 20, and a pull-out permitted state (unlocked state) illustrated in FIG. 3 is sensed by sensing the detector 24 with a lock release sensing sensor 45 fixed to the frame 40 of the coin housing section 3. Specifically, the detector 24 blocks light being emitted by the lock release sensing sensor 45 when the lock lever 20 is rotated in the unlocking direction (counterclockwise rotation) from the state illustrated in FIG. 2 to the state illustrated in FIG. 3, and the lock release sensing sensor 45 senses that pull-out limitation of the coin housing section 3 has been released. When the release of pull-out limitation of the coin housing section 3 has been sensed by the lock release sensing sensor 45, a non-illustrated control section of the money handling device 1 notifies the operator that the pull-out limitation on the coin housing section 3 has been released. This notification may be performed by screen output to a non-illustrated display section, or by voice guidance, as a notification means. This notification may be continued while light blocked by the detector 24 is sensed by the lock release sensing sensor 45. Adopting such an approach enables suppression of a chance that an operator might forget to remove the key even though the coin housing section 3 has been stowed inside the device main body 2.

Note that as illustrated in FIG. 2, the lock mechanism 4 includes a microswitch 44, for sensing whether or not the coin housing section 3 is in a stowed position in the device main body 2, and a switch lever 43 to press the microswitch 44. The switch lever 43 retreats to a position not contacting the microswitch 44 when the coin housing section 3 is in the stowed position, and the microswitch 44 is moved to a pressed position when in a pulled out position. The microswitch 44 accordingly outputs a signal by being pressed by the switch lever 43 in a state in which the coin housing section 3 is pulled out from the device main body 2. The non-illustrated control section of the money handling device accordingly detects the coin housing section 3 being pulled out from the device main body 2 (the coin housing section 3 not being in the stowed position).

### Action of Lock Mechanism According to Exemplary Embodiment

A cycle of actions of the lock mechanism 4 will now be described, with reference to FIG. 4 (see also FIG. 1 to FIG. 3, as appropriate).

As illustrated in FIG. 4 (1), the lock mechanism 4 is disposed with the curve-shaped corner portion 12d of the release lever 12 disposed at a position slightly away from the bottom portion 21 of the lock lever 20 in the locked state. By performing an unlocking operation from this state, the release lever 12 is rotated in the release direction (clockwise rotation), the curve-shaped corner portion 12d of the release lever 12 contacts the bottom portion 21 of the lock lever 20, and raises up the lock lever 20. Making the curve-shaped corner portion 12d of the release lever 12, which is a contact portion with the bottom portion 21 of the lock lever 20, a circular arc shape enables smooth rotation even when in contact.

The engagement portion 23 of the lock lever 20 comes out from the hole 31 of the lock lever receiver 30 due to the lock lever 20 being pushed up by a specific amount by the curve-shaped corner portion 12d, releasing pull-out limitation by the lock lever 20 (namely, an unlocked state is adopted) as illustrated in FIG. 4 (2). The abutting portion of the release lever 12 transitions from being the curve-shaped corner portion 12d to being the left side-edge portion 12c by further rotation in the unlocking direction (clockwise rotation) from the position illustrated in FIG. 4 (2) after the unlocked state was adopted, and also the abutting portion of the lock lever 20 transitions from being the bottom portion 21 to being the corner portion 25 configured by the bottom portion 21 and the right-side wall portions 22. The corner portion 25 of the lock lever 20 abuts the left side-edge portion 12c of the release lever 12 in a state in which rotation is stopped by the release lever limiter section 13.

This means that friction force between the lock lever 20 and the release lever 12 is large due to a release direction (clockwise rotation) rotation limiter position of the lock section 10 being set as a position in which the corner portion 25 of the lock lever 20 contacts the left side-edge portion 12c of the release lever 12, enabling the key insertion portion 11 to be held in the limiter position. Note that the corner portion 25 may result from rounding (may have a circular arc shaped cross-section profile) within a range enabling friction force for holding to be implemented. Namely, the corner portion 25 may be configured with a circular arc shaped profile.

Moreover, the left side-edge portion 12c of the release lever 12 is contacted against the lock lever 20 in the held unlocked state, enabling holding even if the contact point shifts due to component variations or the like. For example, consider a case in which a left side-edge portion 12c of a release lever 12 (namely, a portion that makes contact in the held unlocked state) were to have a circular arc shaped profile. In such cases, the limiter position of the release lever limiter section 13 would be designed based on the following positional relationship: a position furthest from the rotation center axis of the key insertion portion 11 is a position bulging out furthest in a substantially circular arc, and there is a need for the most bulged position of a circular arc to contact the lock lever 20 in order to enable the held unlocked state. However, in cases in which component variation arising from manufacturing processes are considered, there is a concern that the limiter position might be reached in advance of reaching the most bulging position of the circular arc, with this resulting in the held unlocked state not being able to be maintained in such cases. On the other hand, in cases in which it is the left side-edge portion 12c having a straight-line shape as in the present exemplary embodiment that contacts the lock lever 20 in the held unlocked state, as long as some part of the left side-edge portion 12c of the release lever 12 contacts the lock lever 20 then this state can be held, enabling the held unlocked state to be maintained irrespective of component variation. Note that the profile of the left side-edge portion 12c of the release lever 12 (namely, the portion that makes contact in the held unlocked state) may be a profile other than a straight-line shape as long as a need to consider component variation and the like is eliminated and may, for example, be a gently curving circular arc shaped profile.

Moreover, the corner portion 25 of the lock lever 20 contacts the release lever 12 in the held unlocked state, and so space is made for the curve-shaped corner portion 12d of the release lever 12 to escape into in the state illustrated in FIG. 4 (3), so as to enable contact with the left side-edge portion 12c of the release lever 12. Namely, the curve-shaped corner portion 12d of the release lever 12 abuts the bottom portion 21 of the lock lever 20 in the state illustrated in FIG. 4 (2), and to make the left side-edge portion 12c of the release lever 12 to abut the lock lever 20 from this state, there is a need to switch the contact portion of the release lever 12 from being the curve-shaped corner portion 12d to being the left side-edge portion 12c by a process of rotating the release lever 12 with clockwise rotation. Due to the structure of the present exemplary embodiment, the curve-shaped corner portion 12d of the release lever 12 moves toward the right side along the bottom portion 21 of the lock lever 20 and reaches the corner portion 25 by rotating the release lever 12 with clockwise rotation from the state illustrated in FIG. 4 (2). The curve-shaped corner portion 12d accordingly adopts a non-contact state with the lock lever 20 by further rotating the release lever 12, switching such that instead the left side-edge portion 12c of the release lever 12 contacts the corner portion 25 of the lock lever 20 (see FIG. 4 (3)). In the state illustrated in FIG. 4 (3), a holding force can be obtained even without rotating the key insertion portion 11 of the lock section 10 by “90°”, due to the friction force arising from contact between the straight-line shaped left side-edge portion 12c and the corner portion 25, thereby enabling the held unlocked state to be maintained without the need for the operator to continue applying force.

### Principle that Enables the Lock Mechanism According to Exemplary Embodiment to Hold the Unlocked State

The following is a detailed description regarding the above content regarding raising friction force by the corner portion 25 of the lock lever 20 being placed in a state of contact with the left side-edge portion 12c of the release lever 12 in the limiter position, enabling the limiter position to be held.

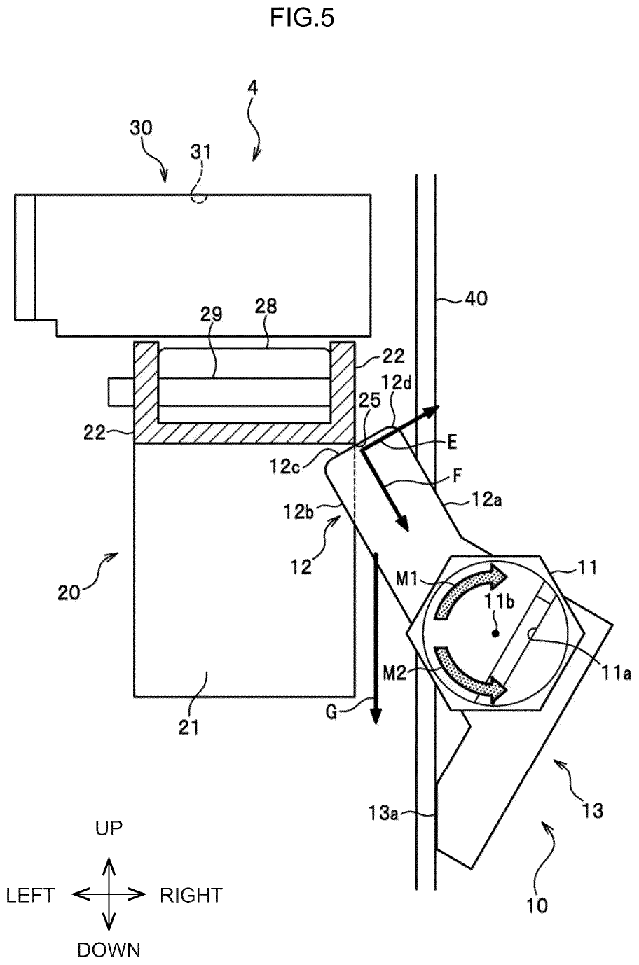

As illustrated in FIG. 5, forces acting on the release lever 12 in the limiter reached position mainly include, (1) a force of gravity G on the release lever 12, (2) a force F imparted by the lock lever 20 to the release lever 12, and (3) friction force E arising from contact between the release lever 12 and the lock lever 20. The force F from the lock lever 20 is, mainly, a combined force from the force of gravity on the lock lever 20, and an elastic force as the deformation of the lock lever spring 28 attempts to return to the original state. The force F from the lock lever 20 acts in a direction orthogonal to the left side-edge portion 12c of the release lever 12.

This means that torque to rotate the release lever 12 in the limiter reached position includes (A) torque from the force of gravity G on the release lever 12, (B) torque from the force F that the lock lever 20 imparts to the release lever 12, and (C) torque from the friction force E due to contact between the release lever 12 and the lock lever 20. These torques are all with respect to a rotation center axis 11b.

As illustrated in FIG. 5, the torque from the force of gravity G on the release lever 12 and the torque from the force F imparted by the lock lever 20 are torques to rotate the release lever 12 in the direction of sign M2, and the torque from the friction force E is a torque to rotate the release lever 12 in the direction of sign M1. The torque to rotate the release lever 12 in the direction of sign M1 is a torque in the unlocking direction (clockwise rotation), and the torque to rotate the release lever 12 in the direction of sign M2 is a torque in the locking direction (counterclockwise rotation). The release lever 12 is able to be maintained in the held unlocked state when the torque M1 in the unlocking direction (clockwise rotation) is larger than the torque M2 in the locking direction (counterclockwise rotation).

Torque from the force F imparted by the lock lever 20 needs to be as small as possible in order to satisfy this condition of the torque M1 in the unlocking direction (clockwise rotation) being larger than the torque M2 in the locking direction (counterclockwise rotation). This means that in order to make the torque from the force F imparted by the lock lever 20 small, a force of the lock lever spring 28 that is a basis thereof needs to be small. If such an approach is adopted, then this is accompanied by a risk of not being able to establish a locked state relationship between members due to a force from the lock lever spring 28 attempting to return the lock lever 20 to horizontal being small, and so there is a limit in how small the force of the lock lever spring 28 can be made.

In the present exemplary embodiment, a direction of the force F imparted by the lock lever 20 is set to face the rotation center axis 11b, by adjusting a positional relationship (and in particular a position of the contact point) between the release lever 12 and the lock lever 20 in the limiter position and adjusting a direction of the left side-edge portion 12c of the release lever 12. In other words, provided so that the rotation center axis 11b is positioned in a direction in which the left side-edge portion 12c of the release lever 12 bears the force F from the lock lever 20. As a result thereof, the torque arising from the force F imparted by the lock lever 20 can be made “0 (zero)” in the end even without the force of the lock lever spring 28 being small. This means that the torque M1 in the unlocking direction (clockwise rotation) can be made larger than the torque M2 in the locking direction (counterclockwise rotation) without a risk of the locked state relationship between members not being established. Ideally in general the torque M1 in the unlocking direction (clockwise rotation) is two or more times the torque M2 in the locking direction (counterclockwise rotation).

Moreover, the direction the lock lever 20 imparts the force F is set as toward the right side (curve-shaped corner portion 12d side) of the rotation center axis 11b by adjusting the direction of the left side-edge portion 12c, resulting in the torque due to the force F imparted by the lock lever 20 being toward the unlocking direction (clockwise rotation). This means that, similarly, the torque M1 in the unlocking direction (clockwise rotation) can be made larger than the torque M2 in the locking direction (counterclockwise rotation) by making the direction of the force F imparted by the lock lever 20 toward the right side of the rotation center axis 11b. However, if the torque M1 in the unlocking direction (clockwise rotation) were to be excessively large then a large force corresponding to the torque M1 would act on the key of the operator when transitioning from the held unlocked state illustrated in FIG. 4 (3) to the locked state illustrated in FIG. 4 (1), resulting in a need to bear in mind that sticking and not returning situations might occur. There is accordingly a need to appropriately select a positional relationship (and in particular a position of the contact point) between the release lever 12 and the lock lever 20 in the limiter position and appropriately select a direction of the left side-edge portion 12c of the release lever 12, and a difference between the torque M1 and the torque M2 should be smaller than torque of a person turning the key.

The lock mechanism 4 according to the present exemplary embodiment, and the money handling device 1 equipped with the lock mechanism 4, are accordingly able to hold the unlocked state in the limiter position as described above. This means that, since the locked state is not returned to even when the operator takes a hand off the key, it is possible for pull out of the coin housing section 3 to be performed with one hand, thereby enabling the operability to be greatly improved.

### Modified Example

Although an exemplary embodiment of the present invention has been described above, the present invention is not limited thereto, and may be implemented within a range not departing from the scope of the patent claims.

For example, although the exemplary embodiment described envisages a pay-in/pay-out machine, the lock mechanism 4 of the present invention is applicable to any device provided with a pull-out section.

Moreover, although in the exemplary embodiment maintaining an unlocked state using the lock mechanism 4 was described, the present invention may be applied to maintaining a locked state.

Moreover, although in the exemplary embodiment a case has been described in which the lock lever 20 is disposed in a horizontal plane in the locked state, the lock lever 20 is not necessarily in a horizontal plane in the locked state.

### Comparative Example

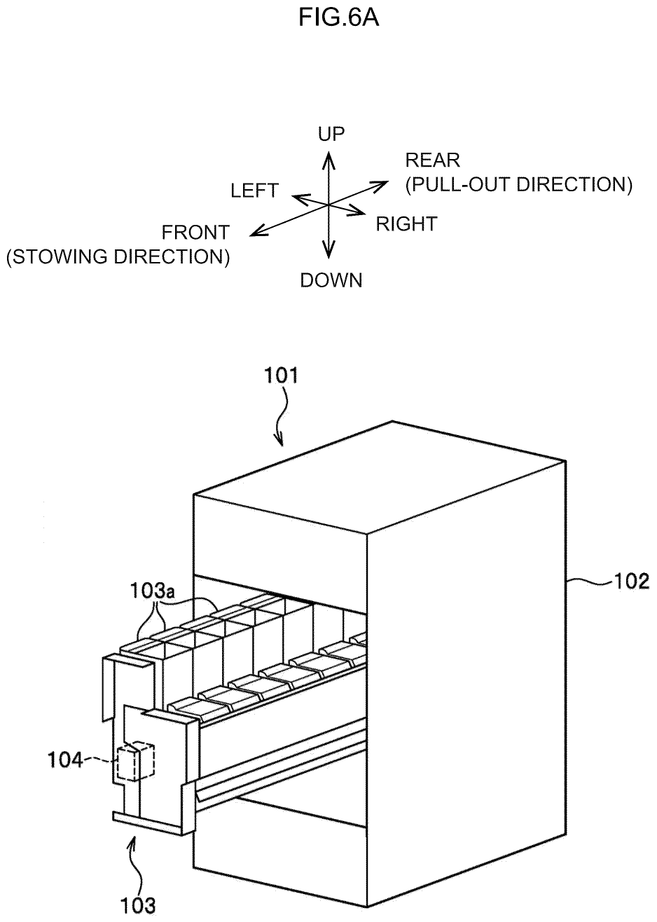

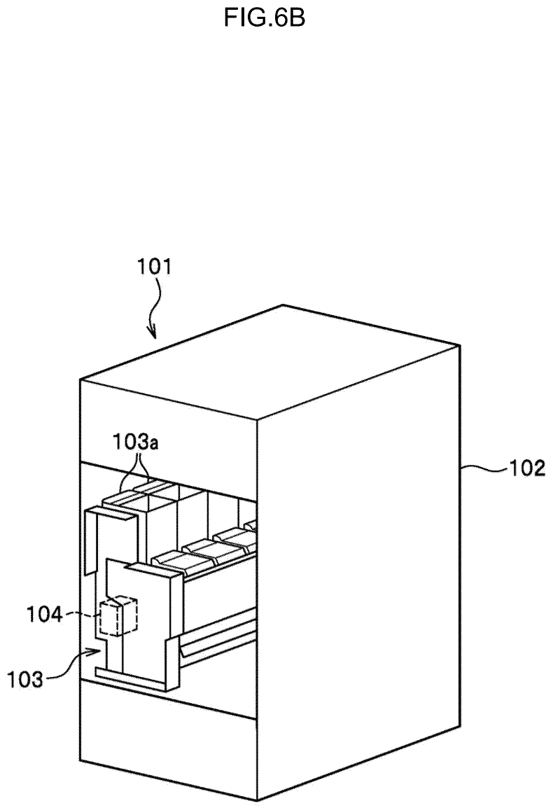

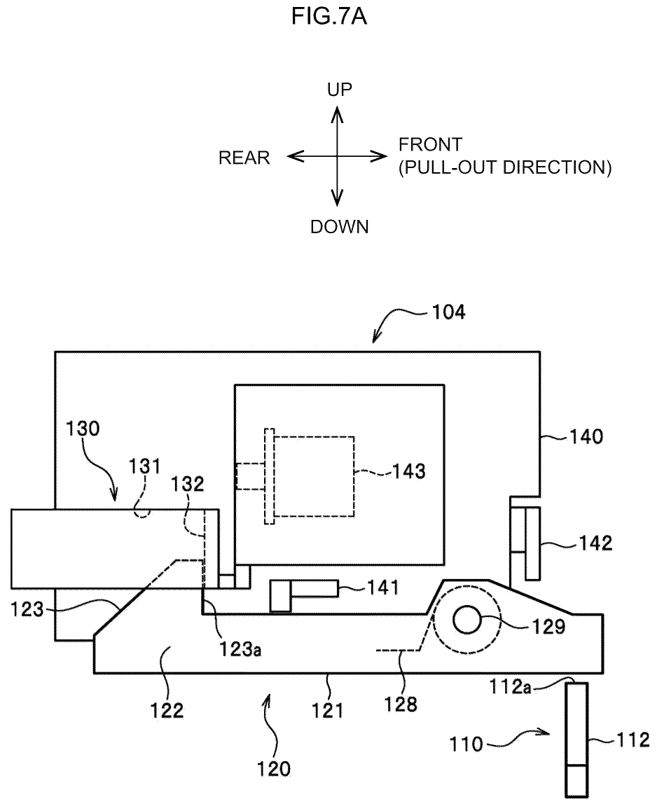

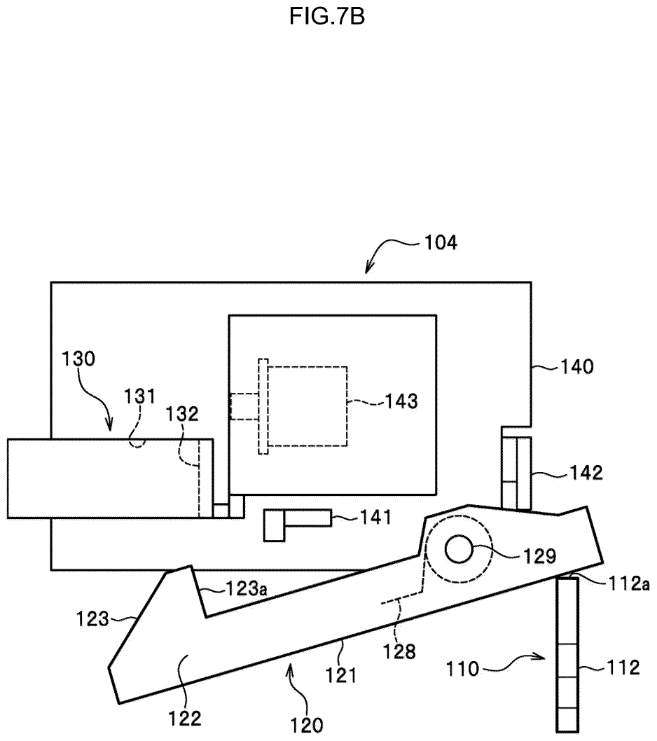

A configuration of a conventional lock mechanism 104, and a money handling device 101 equipped with the lock mechanism 104, are illustrated in FIG. 6A and FIG. 6B to FIG. 8A and FIG. 8B as a comparative example. In FIG. 6A and FIG. 6B to FIG. 8A and FIG. 8B, numbers having the same last two digits are appended to configuration elements corresponding to the configuration elements of the present exemplary embodiment.

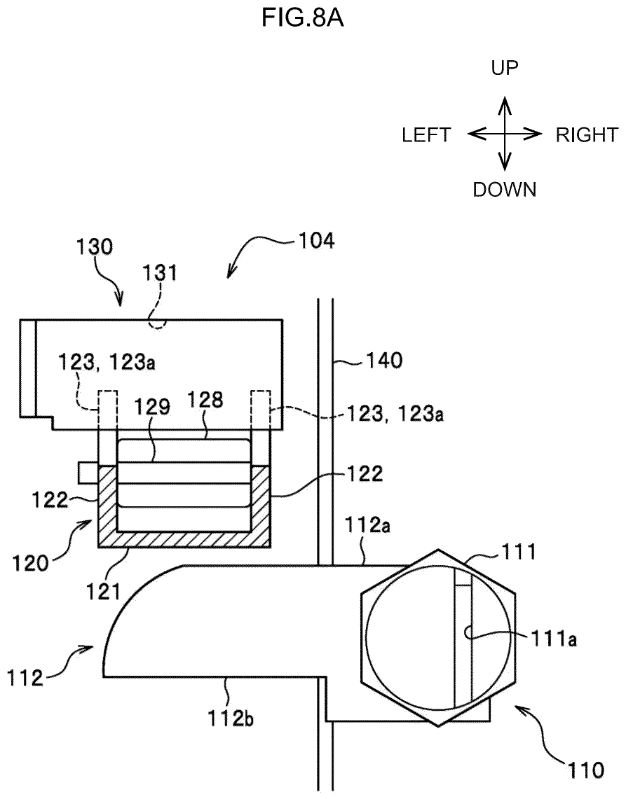

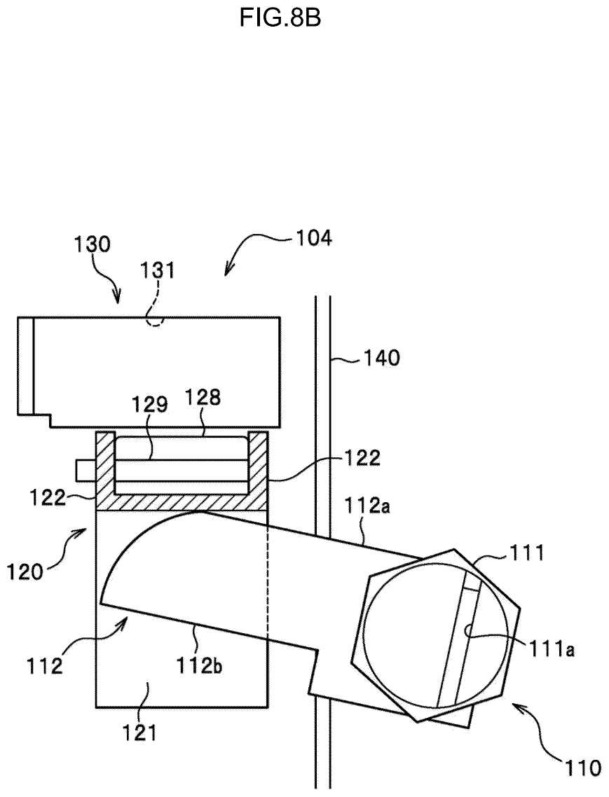

In particular, as illustrated in FIG. 8A and FIG. 8B, a conventional release lever 112 has an upper end portion 112a and a lower end portion 112b that are parallel to each other at a base section thereof, and a curved profile with a rounding extending around a leading end portion thereof. In cases in which the release lever 112 presses the lock lever 120 up, the curved portion formed at the leading end portion of the release lever 112 mainly abuts the lock lever 120.

The entire content of the disclosure of Japanese Patent Application No. 2022-160281 is incorporated by reference in the present specification.

All publications, patent applications and technical standards mentioned in the present specification are incorporated by reference in the present specification to the same extent as if each individual publication, patent application, or technical standard was specifically and individually indicated to be incorporated by reference.

1. A lock mechanism that limits pull-out to outside of a pull-out section provided capable of being stowed inside a casing and also capable of being pulled out to outside from the inside thereof, the lock mechanism comprising:
a lock section including a key insertion portion that is able to be rotated by a specific key being inserted therein;
a release lever that is able to rotate in a locking direction and an unlocking direction interlocked with rotation of the key insertion portion; and
a lock lever that is provided at a position to contact the release lever when the release lever is rotated in the unlocking direction, that permits pull out to outside of the pull-out section when the lock section is in an unlocked state, and that limits pull out to outside of the pull-out section when the lock section is in a locked state, wherein
the release lever is provided with:
a first abutting section that abuts the lock lever by rotation in the unlocking direction and transitions the lock lever to a permitted state permitting pull out of the pull-out section; and
a second abutting section that abuts the lock lever by further rotation in the unlocking direction after the lock lever has been transitioned to the permitted state, and that holds the permitted state of the lock lever.

2. The lock mechanism of claim 1, wherein:
the first abutting section exhibits a circular arc shape;
the second abutting section exhibits a straight-line shape; and
the first abutting section and the second abutting section are formed contiguous to each other.

3. The lock mechanism of claim 1, wherein:
the release lever is a plate shaped member disposed in a flat plane orthogonal to a rotation center axis of the key insertion portion, and is provided capable of rotating about the same axis as the rotation center axis of the key insertion portion;
the first abutting section is a curve-shaped corner portion resulting from imparting rounding to a corner portion of the plate shaped member; and
the second abutting section is one side-edge portion from out of two side-edge portions configuring the curve-shaped corner portion.

4. The lock mechanism of claim 3, wherein:
the release lever is arranged so as to raise the lock lever upward from a lower side by rotating the release lever in the unlocking direction; and
the lock lever includes a flat plane shaped bottom face and a side face formed contiguous to the bottom face, transitions to the permitted state by the first abutting section abutting against the bottom face, and, by further rotating in the unlocking direction, holds the permitted state by the second abutting section abutting against a corner portion configured by the bottom face and the side face.

5. The lock mechanism of claim 3, wherein:
the release lever is provided so as to position the rotation center axis of the key insertion portion in a direction of force the second abutting section bears from the lock lever when holding the permitted state.

6. The lock mechanism of claim 1, wherein:
the release lever rotates in a range narrower than 90°; and
the lock lever is equipped with a biasing means to transition the lock lever to the limited state that limits pull out of the pull-out section.

7. A money handling device comprising:
a casing;
a coin housing section that is provided so as to be capable of being stowed inside the casing and also capable of being pulled out to outside from the inside thereof, and that houses coins by denomination; and
a lock mechanism that limits pull out to outside of the coin housing section, wherein in the money handling device,
the lock mechanism includes:
a lock section including a key insertion portion that is able to be rotated by a specific key being inserted therein,
a release lever that is able to rotate in a locking direction and an unlocking direction interlocked with rotation of the key insertion portion, and
a lock lever that is provided at a position to contact the release lever when the release lever is rotated in the unlocking direction, that permits pull out to outside of the coin housing section when the lock section is in an unlocked state, and that limits pull out of the coin housing section to outside when the lock section is in a locked state; and
the release lever is provided with
a first abutting section that abuts the lock lever by rotation in the unlocking direction and transitions the lock lever to a permitted state permitting pull out of the coin housing section, and
a second abutting section that abuts the lock lever by further rotation in the unlocking direction after the lock lever has been transitioned to the permitted state, and that holds the permitted state of the lock lever.

8. The money handling device of claim 7, wherein:
the lock lever includes a detector; and
the lock mechanism is equipped with a release sensing sensor to detect a permitted state by light being blocked by the detector in a state that is the permitted state with the permitted state being held.

9. The money handling device of claim 8, further comprising:
a control section and a notification means; and
the control section employs the notification means to notify being in the permitted state when the permitted state has been detected by the release sensing sensor.
